(19) United States
(12) Patent Application Publication
(10) Pub. No.: US 2026/0044392 A1
(43) Pub. Date: Feb. 12, 2026

(54) LARGE LANGUAGE MODEL (LLM)-BASED AGENT OPERATING SYSTEMS

(71) Applicant: Rutgers, The State University of New Jersey, New Brunswick, NJ (US)

(72) Inventors: Yongfeng Zhang, Piscataway, NJ (US); Kai Mei, Edison, NJ (US)

(73) Assignee: Rutgers, The State University of New Jersey, New Brunswick, NJ (US)

(21) Appl. No.: 19/284,970

(22) Filed: Jul. 30, 2025

Related U.S. Application Data
(60) Provisional application No. 63/681,250, filed on Aug. 9, 2024.

(51) Int. Cl. G06F 9/54; G06F 9/48; G06F 21/62

(52) U.S. Cl. CPC G06F 9/54; G06F 9/4881; G06F 21/6218

(57) ABSTRACT

This disclosure describes a large language model (LLM)-based agent operating system comprising an application layer, a kernel layer, and a hardware layer. The kernel layer comprises an AIOS kernel comprising: LLM core(s), an agent scheduler, a context manager, a memory manager, a storage manager, and a system call interface configured to manage interactions among the agent scheduler, the context manager, the memory manager, and the storage manager.

### CROSS-REFERENCE TO RELATED APPLICATIONS

This application claims priority under 35 U.S.C. § 119(e) to U.S. Provisional Patent Application No. 63/681,250, filed Aug. 9, 2024. The foregoing application is incorporated by reference herein in its entirety.

### FIELD

This invention relates generally to a large language model (LLM)-based agent operating system.

### BACKGROUND

In the field of autonomous agents, research endeavors are directed towards systems that can operate independently, make decisions, and perform tasks with no or minimal human intervention. These agents are designed to understand instructions, process information, make decisions and take action to achieve a state of autonomy. The advent of large language models (LLMs) has brought new possibilities to the agent development. Current LLMs have shown great power in understanding instructions, reasoning and solving problems, and interacting with human users as well as external environments. Built upon these powerful LLMs, emergent LLM-based agents can present strong task fulfillment abilities in diverse environments, ranging from virtual assistants to more sophisticated systems involving complex and creative problem solving, planning and reasoning.

One compelling example of how an LLM-based agent (e.g., travel agent) solves real-world tasks can be seen from FIG. 1. Given the trip organization request from the user, the travel agent decomposes the task into executable steps. Then, it follows the steps sequentially to book flights, reserve hotels, process payments, and update calendars based on the user's preferences. During the plan execution, agents show the reasoning and decision-making abilities, which sets it apart from the traditional software applications that are constrained to a pre-defined set of functions or workflow. To realize this travel scenario, the agent needs to interact with both LLM services (e.g., retrieving and understanding user preferences, deciding which tool API to call, generating reviews and responses) and traditional operating system (OS) services (e.g., accessing disk driver and executing software).

Accompanied by the exponential growth in the agent quantity and complexity, there is an increasing strain on the functionalities of LLM and OS. For example, scheduling and prioritizing agent requests in limited LLM resources poses a significant challenge. Moreover, the LLM's generation process can become time-intensive when dealing with lengthy contexts, occasionally resulting in the generation being suspended by the scheduler. This raises the problem of devising a mechanism to snapshot the LLM's current generation result, thereby enabling pause/resume behavior even when the LLM has not finalized the response generation for the current request. Furthermore, once an agent has obtained the list of available calling tools, determining the optimal sequence for invoking these tools presents yet another challenge since multiple agents may need to call the same tool. Additionally, the concurrent operation of multiple agents necessitates a robust system for memory management across different agents, while also ensuring stringent enforcement of privacy and access control measures.

### SUMMARY

This disclosure addresses the need mentioned above in a number of aspects. In one aspect, this disclosure provides a large language model (LLM)-based agent operating system comprising an application layer, a kernel layer, and a hardware layer. In some embodiments, the kernel layer comprises a kernel comprising: one or more LLM cores to process agent requests and/or prompts; an agent scheduler configured to prioritize and schedule agent requests from one or more agents to optimize LLM utilization; a context manager configured to support context management during a generation process of LLM responses; a memory manager configured to manage short-term or long-term memory or context information for each agent's interaction logs; a storage manager configured to persist agent interaction logs or knowledge base to long-term storage for future retrieval; and a system call interface configured to manage interactions among the agent scheduler, the context manager, the memory manager, and the storage manager.

In some embodiments, the agent operating system further comprises a tool manager configured to manage tool calling of the agents. In some embodiments, the agent operating system further comprises an access manager configured to enforce security, privacy and access control policies between the agents, and between the agents and the agent operating system.

In some embodiments, the agent operating system further comprises an agent operating system-agent SDK that interfaces agents and the kernel layer. In some embodiments, the agent operating system-agent SDK comprises one or more toolkits for developing agent applications.

In some embodiments, the kernel layer further comprises an OS kernel. In some embodiments, the agent operating system-agent SDK directs LLM or non-LLM related calls to the agent operating system kernel and the OS kernel respectively.

In some embodiments, the agent scheduler manages the agent requests and balances waiting time and turnaround time of each agent request. In some embodiments, the agent scheduler manages the agent requests based on First-In-First-Out, Round Robin, or other scheduling algorithms.

In some embodiments, the context manager supports context interruption and switching based on context snapshot and context restoration mechanisms. In some embodiments, the snapshot and context restoration mechanisms are text-based or logits-based.

In some embodiments, the memory manager manages memory or context within each round of an agent interaction. In some embodiments, the memory manager stores memory or context of an agent and permits access to the memory only when the agent is active, either waiting for execution or during execution.

In some embodiments, the storage manager manages long-term preservation of data and storage of information that needs to be retained beyond an active lifespan of an agent.

In some embodiments, the tool manager manages a diverse array of API tools that enhance the functionality of a LLM or agent.

In some embodiments, the access manager provides security and privacy guarantee and access control among distinct agents by administering a dedicated privilege group for each agent.

In some embodiments, the agent operating system is implemented with one or more LLMs in the agent operating system kernel.

In some embodiments, the application layer comprises one or more agent applications. In some embodiments, the agent applications are LLM-based applications.

In some embodiments, the hardware layer comprises CPU, GPU, memory, disk, and/or peripheral devices.

The foregoing summary is not intended to define every aspect of the disclosure, and additional aspects are described in other sections, such as the following detailed description. The entire document is intended to be related as a unified disclosure, and it should be understood that all combinations of features described herein are contemplated, even if the combinations of features are not found together in the same sentence, or paragraph, or section of this document. Other features and advantages of the invention will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### BRIEF DESCRIPTION OF THE DRAWINGS

FIG. 1 shows a motivating example of how an agent (i.e., travel agent) requires both LLM-related and non-LLM-related (i.e., OS) function calls to complete a task.

FIG. 2 shows an overview of the AI Agent Operating System (“AIOS”) architecture comprising distinct functional layers. The application layer is configured to facilitate the design, development, and execution of agent-based applications. The kernel layer is responsible for managing core system functionalities and computational resources that support the execution of agent applications. The hardware layer interfaces with and manages physical computing resources and devices, providing foundational support for operations performed by the kernel layer.

FIG. 3 shows the decomposition of agent queries into AIOS system calls and the subsequent dispatch and scheduling of those system calls by the AIOS scheduler. The access manager module is not shown in this figure, as system calls related to access control are handled separately and are not dispatched by the scheduler.

FIG. 4 shows an illustration of the agent scheduler.

FIG. 5 shows a complete logits-based context snapshot and restoration process using beam search algorithm (beam width=1) as an example.

FIG. 6 shows a schematic illustration of the memory manager and storage manager, and their operational relationship. As shown, when an agent's memory usage exceeds a predefined threshold—set by default to 80% of the allocated memory block size—the memory manager triggers eviction of one or more memory items to the storage managed by the storage manager. The memory usage threshold is configurable via the AIOS configuration parameters.

FIG. 7 shows the impact of the increase of agent instances on the time latency (average), where avg-A and avg-R denote the agent level average values and agent-request level average values, respectively.

FIGS. 8A and 8B show graphs illustrating the efficiency analysis of various agent frameworks when evaluated using the Llama-3.1-8B model on the HumanEval benchmark.

FIGS. 9A and 9B show graphs illustrating the efficiency analysis of various agent frameworks evaluated using the Mistral-7B model on the HumanEval benchmark.

FIG. 10 shows the overall execution time and the average agent waiting time as the number of agents increases from 250 to 2,000. The figure demonstrates how system performance scales with agent population, highlighting trends in computational load and latency experienced by individual agents.

FIG. 11 shows a graphical representation of the efficiency analysis of various agent frameworks evaluated using the Llama-3.1-8B model on the MINT benchmark.

FIG. 12 shows a graphical representation illustrating an efficiency analysis of various agent frameworks evaluated using the Mistral-7B model on the MINT benchmark.

FIG. 13 shows an efficiency analysis comparing various agent frameworks when evaluated using the Llama-3.1-8B model on the GAIA benchmark.

FIG. 14 shows a graph illustrating the efficiency analysis of various agent frameworks evaluated using the Mistral-7B model on the GAIA benchmark.

FIG. 15 shows a graph illustrating the efficiency analysis of various agent frameworks evaluated using the Llama-3.1-8B model on the SWE-Bench-Lite benchmark.

FIG. 16 shows a graph illustrating the efficiency analysis of various agent frameworks evaluated using the Mistral-7B model on the SWE-Bench-Lite benchmark.

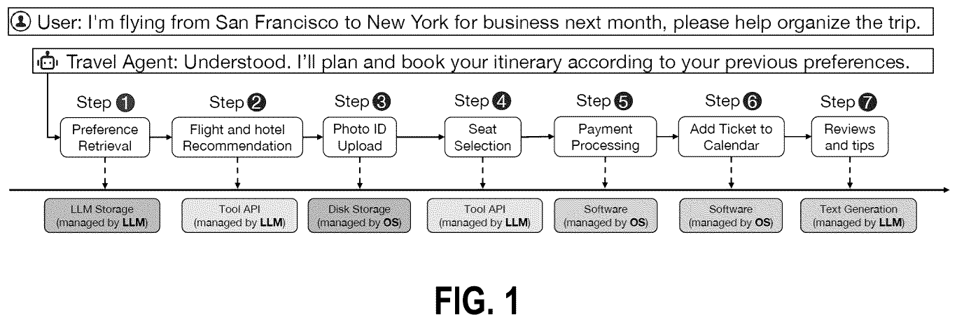

### DETAILED DESCRIPTION

The integration and deployment of large language model (LLM)-based intelligent agents present a variety of challenges that adversely affect system efficiency and operational reliability. These challenges include, but are not limited to, sub-optimal scheduling and resource allocation of agent requests to the underlying LLM, difficulties in preserving conversational and operational context between the agent and the LLM, and the complexity of integrating heterogeneous agents possessing varying capabilities and functional specializations. The increasing number and complexity of such agents further exacerbate these challenges, often resulting in performance bottlenecks and inefficient utilization of system resources.

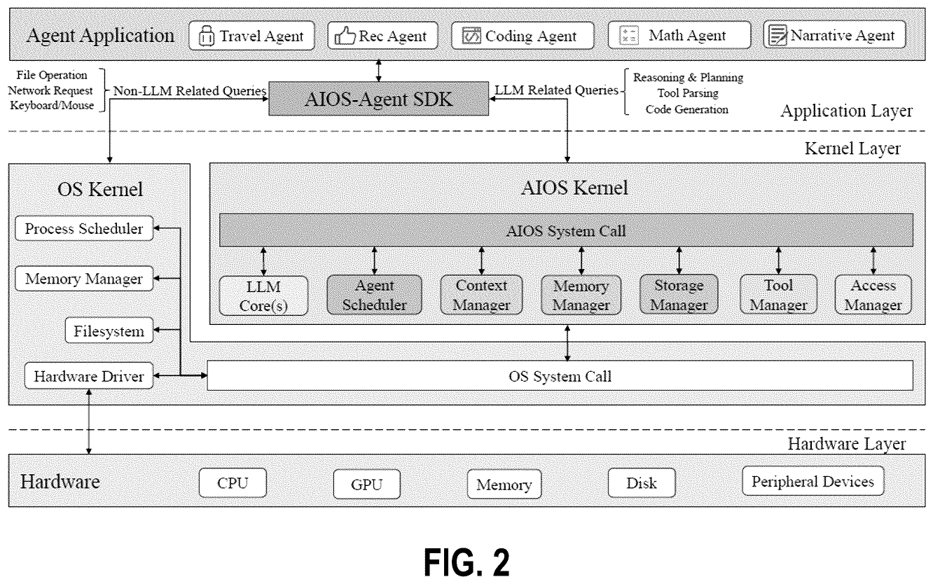

To address these and other challenges, the present disclosure provides a novel agent operating system, referred to herein as AI Agent Operating System (“AIOS”), which is specifically designed to support LLM-based intelligent agents. As illustrated in FIG. 2, AIOS integrates functional modules that combine capabilities of conventional operating systems with LLM-specific coordination features. The AIOS architecture supports modular isolation and aggregation of LLM and OS-level services to enable robust and scalable agent execution.

In certain embodiments, AIOS is configured to optimize computational resource allocation, manage context switching between agents, support concurrent agent execution, offer tool services to agent processes, and enforce fine-grained access control mechanisms for secure agent interactions. The architecture, design, and implementation details of AIOS are described herein, along with the core technical challenges it is intended to resolve. Experimental evaluations involving simultaneous execution of multiple agents confirm the effectiveness and performance advantages of the disclosed AIOS modules.

To further enhance system efficiency, particularly in environments where LLM-related and non-LLM-related tasks coexist, the present disclosure also describes the design of an LLM-specific kernel (AIOS kernel). This LLM kernel provides a logical and operational separation of concerns by isolating duties related to LLM agent oversight, including task scheduling, memory and resource management, and support for development toolkits. By segregating these OS-like responsibilities, the LLM kernel facilitates improved coordination and management of LLM-centered activities.

The LLM kernel includes a suite of modular components, each configured to support a distinct LLM-related function. The modules and their respective functionalities are described in further detail below.
LLM Core(s): LLM Core(s) abstract one or more LLM instances-regardless of deployment configuration—as a modular processing unit with standardized system calls, enabling flexible and extensible integration within the AIOS architecture.
Agent Scheduler: Prioritizes and schedules agent requests to optimize LLM utilization.
Context Manager: Supports context management (context snapshot and restoration) during the generation process of LLM response.
Memory Manager: Manages short-term or long-term memory or context information for each agent's interaction logs.
Storage Manager: Persists agent interaction logs or knowledge base to long-term storage for future retrieval.
Tool Manager: Manages the external tool calling of agents.
Access Manager: Enforces security, privacy and access control policies between agents, and between agents and the agent operating system.

Aside from the modules, the kernel exposes an AIOS system call interface through which agents can transparently leverage these services. Moreover, the AIOS-Agent SDK was designed to provide more convenient agent library functions for agent developers. With the AIOS architecture, an agent such as the travel agent can break down its task into steps that fluidly combine LLM reasoning (e.g., plan generation and tool calling decision) and OS-level actions (e.g., accessing storage and executing software services). This synergistic combination of capabilities equips multiple LLM agents to tackle increasingly complex, multi-modal tasks that require reasoning, execution, and interaction with the physical world.

The AIOS as disclosed herein can be extended to support even tighter agent-world integration (e.g., through robotic control), more intelligent resource management, and safer multi-agent collaboration. Ultimately, AIOS serves as the crucial platform to facilitate the development, deployment and usage of various complex LLM agents.

The evolution of OS has unfolded in a progressive way, evolving from rudimentary systems to the complex and interactive OS of today. Initially, operating systems served to bridge the gap between the user-level tasks and the binary functionality of computer hardware, such as electron and gate manipulation. Their evolution saw a transition from simple batch job processing to more advanced process management techniques like time-sharing and multi-task processing, which facilitated the handling of increasingly complex tasks. The progress moved toward modularization within the OS, delineating specific responsibilities such as process scheduling, memory management, and filesystem management, enhancing efficiency and manageability. The further advent of graphical user interfaces (GUIs), e.g., Macintosh, Windows and GNOME, makes operating systems more interactive and user-centric. Meanwhile, the operating system ecosystem has also expanded, offering a comprehensive suite of developer tools (OS SDKs) and runtime libraries. These tools enable application developers to design, implement, and run their applications efficiently within the OS environment. Notable examples of OS ecosystems include Android Studio, Xcode, and Cloud SDK. In these ecosystems, the OS provides numerous resources to facilitate software development and serves as a platform for deploying and hosting software applications, leading to a thriving OS-application ecosystem.

Before the dawn of LLM, AI was studied primarily at the application level. This was because there was hardly any “standard” AI model—different AI sub-areas, or even different problems in the same area, require very specialized models for individual tasks, making it difficult to integrate AI models into the system level as standard services. With the prospering of LLM, AI models are becoming more and more “unified” and “standardized”. Because of this, the community is seeing AI models such as LLMs sinking from the application layer down to the system layer to provide standard services to various applications. With the incorporation of LLMs, these advanced systems promise to further narrow the communication gap between humans and machines, forwarding a new era of user-computer interaction.

### Large Language Model Agents

LLM-based autonomous agents take natural language instructions as input for complex task solving. The research on LLM-based agents can be generally classified into single-agent systems and multi-agent systems.

LLM-based Single-Agent Systems. LLM-based single-agent systems (SAS) use a single LLM agent for complex task solving, such as travel planning, personalized recommendation, and artistic design. The agent takes natural language instruction from users as input and decomposes the task into a multistep plan for task solving, where each step may call external tools to be completed, such as collecting information, executing specialized models, or interacting with the external world. Single-agent applications may engage with either digital environment or physical environment or both, depending on the task to solve. For example, agents in virtual or digital environment may invoke APIs, browse websites, or execute codes, while agents in the physical environment may manipulate objects, carry out lab experiments, or make actionable decisions.

LLM-based Multi-Agent Systems. LLM-based multi-agent systems (MAS) leverage the interaction among multiple agents for problem solving. The relationship among the multiple agents could be cooperative, competitive, or a mixture of cooperation and competition. In cooperative multi-agent systems, each agent takes and assesses the information provided by other agents, thereby working together to solve complex tasks, such as role playing, social simulation and software development. In competitive multi-agent systems, agents may debate, negotiate and compete with each other in a game environment to achieve their goals, such as improving negotiation skills and debating about the correct answer. Some multi-agent systems may exhibit both cooperation and competition among agents. For example, WarAgent models each country as an LLM-based agent to study how the interaction between countries can lead to international conflicts, where countries may cooperate with each other, such as establishing alliances and making peace agreements, or compete with each other, such as arms race, mobilization, and declaring wars.

### AIOS Layers

As depicted in FIG. 2, the architecture of the AIOS is organized into three distinct layers: the application layer, the kernel layer, and the hardware layer. This layered architecture ensures a clear delineation of responsibilities across the system. Each higher layer abstracts the complexities of the layers below it, facilitating interaction through interfaces or specific modules, thereby enhancing modularity and simplifying system interactions across different layers.

Application Layer. At the application layer, agent applications, such as travel agent or math agent, are developed and deployed. In this layer, AIOS provides the AIOS SDK, with a higher abstraction of system calls that simplifies the development process for agent developers. This SDK allows for development of agent applications by offering a rich toolkit that abstract away the complexities of lower-level system functions. This enables developers to dedicate their focus to the essential logic and functionalities of their agents, facilitating a more efficient development process.

Kernel Layer. The kernel layer is divided into two primary components: the OS Kernel and the LLM Kernel (AIOS Kernel), each serving the unique requirements of non-LLM and LLM-specific operations, respectively. This distinction allows the LLM kernel to focus on LLM specific tasks such as context management and agent scheduling, which are essential for handling LLM-related activities and are not typically within the purview of standard OS kernel functions. The work primarily concentrates on enhancing the LLM kernel without making significant alterations to the existing OS kernel structure. The LLM kernel is equipped with several key modules, including the LLM system call interface, LLM core(s), agent scheduler, context manager, memory manager, storage manager, tool manager, and access manager. These components are designed to address the diverse execution needs of agent applications, ensuring efficient management and execution within the AIOS framework. The specifics of these modules will be further detailed in Section 4.

Hardware Layer. The hardware layer comprises the physical components of the system, including the CPU, GPU, memory, disk, and peripheral devices. It is crucial to note that the LLM kernel's system calls cannot directly interact with the hardware. Instead, these calls interface with the OS's system calls, which in turn manage the hardware resources. This indirect interaction ensures a layer of abstraction and security, allowing the LLM kernel to leverage hardware capabilities without requiring direct hardware management, thus maintaining the system's integrity and efficiency.

### AIOS Implementation

In this section, an overview of the fundamental design and implementation of each module within the LLM kernel is presented. Subsequently, the LLM system calls, which encompass essential functions for each module, are described. At last, the exploration of the AIOS SDK is presented, aiming to facilitate the development process for agent developers.

### Relationship and Connection Between Modules

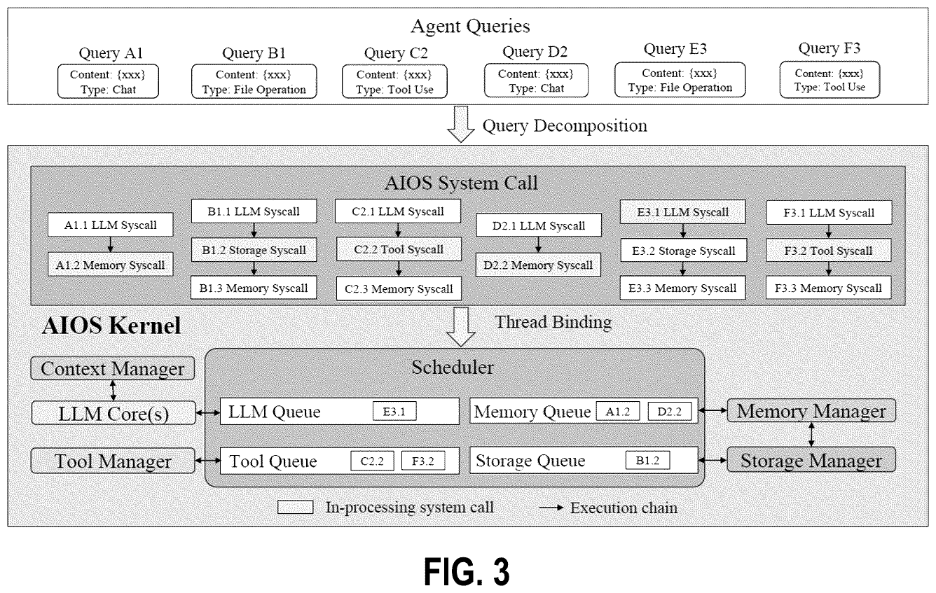

Within the AIOS kernel, agent queries are decomposed into categorized system calls, including but not limited to LLM processing, memory access, storage operations, and tool usage, as illustrated in FIG. 3. Each system call is thread-specific and is dispatched by a centralized scheduler, which manages the execution queue across all modules.

System calls are routed to the appropriate module-specific queues based on predefined attribute sets associated with each call. Each module continuously monitors its respective queue and retrieves system calls scheduled for execution. The context manager is invoked to handle context-switching or interruption events and operates independently of the scheduler, such that it is not subject to scheduled dispatch.

### LLM Core(s)

Given the variety of deployment options for LLMs—including, for example, the specific type of LLM employed, whether the LLM is hosted on a cloud platform or on a local device, the hardware requirements of the LLM, and the particular inference framework utilized—each LLM instance configured with a distinct deployment option is encapsulated as a core, analogous to a CPU core in a traditional operating system.

This abstraction enables each LLM instance to be treated as an independent processing unit, thereby enhancing modularity and extensibility within the AIOS architecture. To support heterogeneous LLM instances, a wrapper module is provided for each LLM core. The wrapper implements a standardized set of system calls specific to LLM inference, thereby facilitating uniform interaction with the underlying LLM regardless of its deployment configuration.

By abstracting each LLM instance as a core and standardizing system call interfaces within the wrapper, the system enables seamless integration and coordination of multiple LLM cores under varying deployment environments. This modular design provides architectural flexibility and scalability for AIOS.

### Agent Scheduler

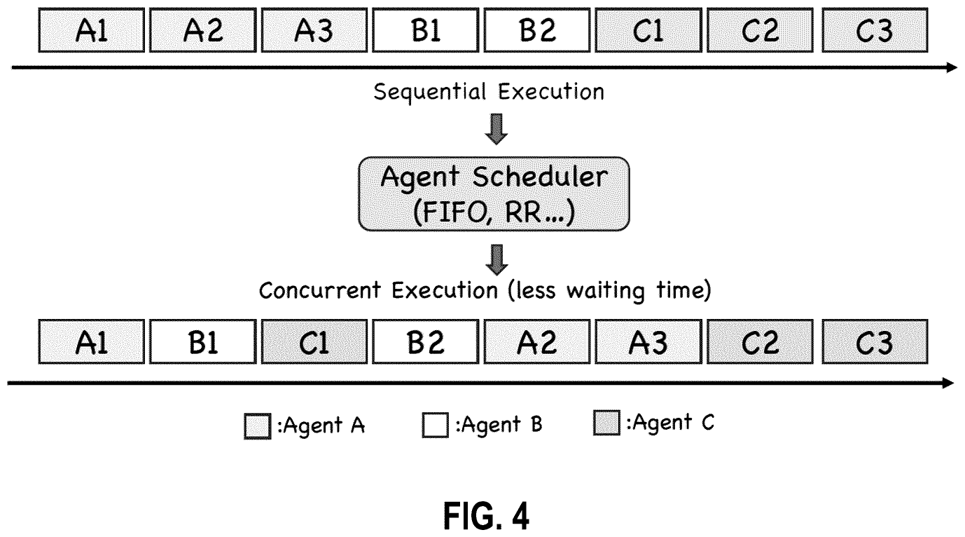

Agent scheduler is designed to manage the agent requests in an efficient way. Consider the various agents (denoted as A, B, and C) in FIG. 4, each of which has several execution steps. In the sequential execution paradigm, the agent tasks are processed in a linear order, where steps from the same agent will be processed first. This can lead to potentially increased waiting times for tasks queued later in the sequence.

The agent scheduler employs strategies such as First-In-First-Out (FIFO) and Round Robin (RR). Through concurrent execution, the scheduler significantly balances waiting time and turnaround time of each agent request, as tasks from different agents are interleaved and executed concurrently. This concurrent approach is visualized through a timeline where tasks from different agents are processed in an interleaved manner (e.g., A1, B1, C1, B2, A2, A3, C2, C3), ensuring that no single agent monopolizes the processing resources and that idle times are minimized.

### Context Manager

The context manager is responsible for managing the context provided to LLM and the generation process given certain context. Scheduler algorithms, such as Round-Robin, may involve time quantum operations, and agent requests can be paused by the scheduler even if the LLM has not fully generated a response. This necessitates a mechanism to switch context from one agent to another while preserving the intermediate generation results of the previous agent. To address this need, AIOS introduces two essential functionalities: context snapshot and context restoration, which support context interruption and switching.

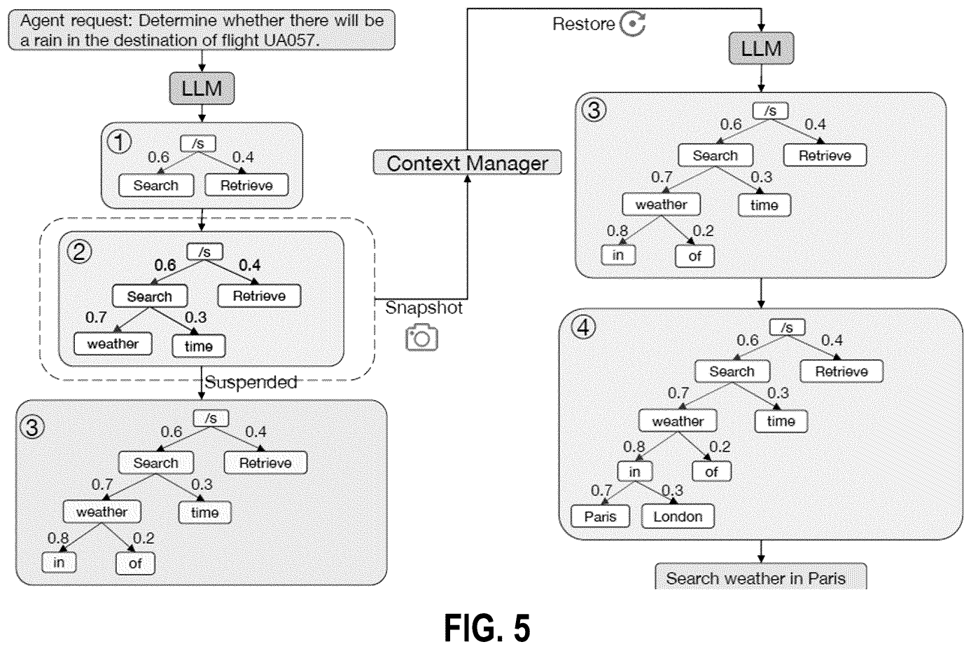

AIOS offers two types of snapshot and restoration mechanisms: text-based and logits-based. The text-based mechanism saves the decoded texts of intermediate outputs with the highest probabilities. In contrast, the logits-based mechanism preserves the intermediate search-tree during generation. The detailed procedure for the logits-based mechanism is illustrated in FIG. 5. The beam search process, a typical practice in LLMs, was used to illustrate the generative decoding process. For simplicity of illustration, the beam width was set as 1. Specifically, consider the agent request as: Determine whether there will be a rain in the destination of flight UA057. At each step, the LLM evaluates multiple potential candidates, with the most promising paths kept for further expansion based on the predefined beam width. When such generation process has been suspended by the scheduler at an intermediate step, the context manager uses the snapshot function to capture and store the current intermediate outputs of the LLM. Upon resumption, the restoration function is employed to reload the saved output from the snapshot, allowing the LLM to continue its generation process exactly from the point of suspension to reach the final answer: Search weather in Paris. In this way, the context manager ensures that the temporary suspension of one agent's request does not lead to a loss of progress, thereby improving efficiency as it does not need to generate from the scratch.

### Memory Manager

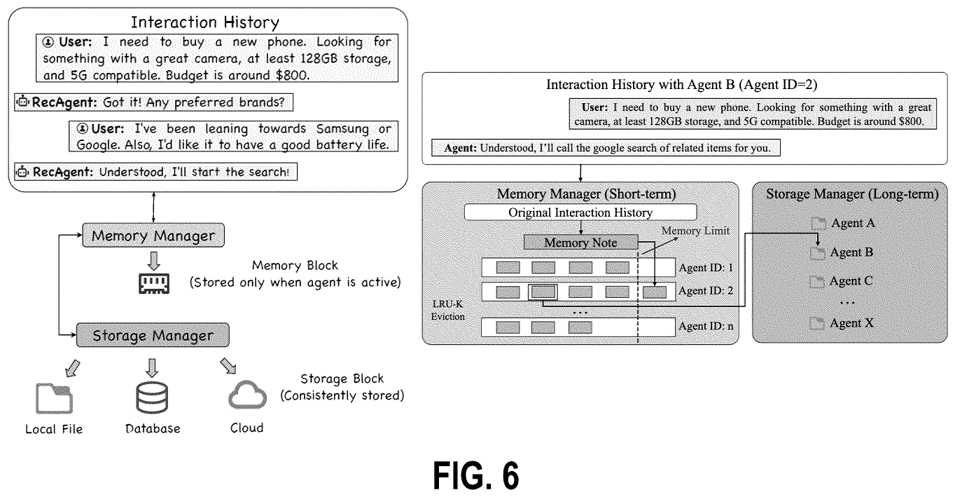

As shown in FIG. 6, memory manager manages short-term or long-term memory or context information within an agent's lifecycle. Here, each round of the agent interaction was considered, i.e., the (query, response) pair, with either the LLM or external tools as the response generator. Agent's memory is stored and accessible while the agent is active, either waiting for execution or during execution. As memory items often contain redundant information (queries in later rounds may include context from previous queries), the prefix-tree based method was utilized to compress memory, thus reducing the physical memory load.

Unlike traditional OS memory managers that manage physical RAM, the AIOS memory manager is specifically designed to handle agent interaction histories during runtime, including conversation logs, context information, and tool-calling results. The memory manager is responsible for managing the structure and organization of agent memory, as well as performing memory allocation, read and write operations, deletion, and updates. By default, agent memory resides in RAM. However, when the allocated memory space approaches its capacity threshold, the memory manager implements a memory swapping mechanism between RAM and disk. For example, when an agent's memory usage exceeds a predefined threshold (e.g., 80% of its allocated block), the memory manager invokes a K-Least Recently Used (LRU-K) eviction policy. Under this policy, memory items that have been accessed at least K times recently are preferentially retained in RAM, whereas items accessed less frequently are transferred to disk by the storage manager. This approach balances memory efficiency and responsiveness by prioritizing in-memory access to frequently used data while offloading less-relevant data to secondary storage for later retrieval. The memory manager may also store long-term memory on disk that the agent decides to be important and may need to access in the future.

### Storage Manager

The storage manager is responsible for the long-term preservation of data, overseeing the storage of information that needs to be retained beyond the active lifespan of any single agent. In AIOS, this permanent storage is achieved through various durable mediums such as local files, databases, and cloud services. By persistently storing information such as agent interaction logs and knowledge base, the storage manager can enhance agent knowledge updates through retrieval-augmented generation (RAG), thereby improving agent performance. Similar to the memory manager, a prefix-tree method is employed to compress both local and cloud storage files.

The storage manager is responsible for managing persistent data storage for agents. This includes storage of files and knowledge bases required for agent operation, as well as agent memory data that must be retained across sessions. During runtime, when an agent's memory usage exceeds a predefined threshold, the memory manager invokes the storage manager to offload data to persistent storage (e.g., disk). The storage manager performs read and write operations based on an agent identifier (agent ID) provided by the memory manager.

In addition to requests initiated by the memory manager, the agent itself may initiate data read or write operations during runtime. Such agent-initiated operations are handled through the agent's invocation of a storage application programming interface (API) provided within the software development kit (SDK). These API calls are translated into storage-related system calls by the runtime environment and placed into a storage queue by the scheduler.

The storage manager processes system calls in the storage queue to fulfill agent data requests. The storage system is implemented using a combination of local file storage and a vector database to support both conventional and semantically indexed data storage.

### Tool Manager

The tool manager in the AIOS system manages a diverse array of API tools that enhance the functionality of LLMs. To facilitate agent development in the AIOS ecosystem, tools from various sources (e.g., Google API, Rapid API hub, Hugging Face, MCP Servers, etc.) are collected, considering both online and offline tools and different input-output modalities to cover as many scenarios of agent tool-using as possible.

Standardized Tool Loading. In some embodiments, the tool manager employs a standardized tool loading interface that enables uniform handling of diverse tools. This interface performs parameter validation prior to execution to ensure compliance with predefined input constraints and to mitigate the risk of runtime errors or tool failures. Upon invocation of a tool by name, the tool manager dynamically loads the corresponding tool instance, which includes initialization of executable components and verification of associated dependencies.

Resolution of Tool Call Conflicts. In some embodiments, the system further addresses tool call conflicts arising from parallel access limitations. The tool manager utilizes a hashmap-based monitoring mechanism to track the number of active instances for each tool in real time. During request processing, the system evaluates the hashmap against predefined usage limits and parallel execution constraints. If a potential conflict is detected, the system defers execution of the current request and advances to evaluate subsequent entries in the request queue until a non-conflicting tool invocation candidate is identified.

### Access Manager

The access manager is a crucial component in modern systems. AIOS supports access control among distinct agents by administering a dedicated privilege group for each agent. Those other agents that are excluded from an agent's privilege group are denied access to its resources, such as the interaction history with the LLM and the logs of calling tools.

Access Control. In some embodiments, an access manager is provided to regulate cross-agent data read and write operations by implementing a privilege-based access control mechanism. The access manager assigns each agent to a designated privilege group and enforces access permissions through a data structure, such as a hashmap, which maps agent identifiers (IDs) to their corresponding privilege groups. Upon receiving an access request from an agent, the access manager validates the request against the established permission structure. Only if the requesting agent's privilege group permits access to the target resource is the operation allowed to proceed. This ensures that agents may only access data or resources associated with other agents when both reside within a shared or authorized privilege domain.

User Intervention. In some embodiments, a user intervention interface is provided to mitigate the risk of executing potentially irreversible operations, such as deletion, overwriting of data, or modification of privilege settings. The interface is configured to prompt for and require explicit user confirmation prior to performing such operations. This safeguard ensures that destructive or security-sensitive actions are not executed without deliberate user oversight and authorization.

### AIOS System Call

AIOS system call interface within the LLM kernel is designed to offer basic AIOS system call operations. This interface acts as a bridge between complex agent requests and the execution of different LLM kernel's modules. Analogous to OS system calls, AIOS system calls offer a suite of basic functions that span across the LLM kernel's modules, including agent management, context handling, memory and storage operations.

In the AIOS framework, each functional module achieves its respective operations by invoking one or more system calls. Table 1 provides a detailed mapping between the system calls and their corresponding modules, along with the parameters or arguments required for each invocation.

TABLE 1
AIOS modules and their correspondent system calls.

| Module | System Call(s) |
|---|---|
| LLM Core(s) | execute_llm_syscall, get_model_response, |
| | process_model_response |
| Scheduler | execute_syscall, start, stop |
| Context Manager | generate_response_with_interruption, |
| | load_context, clear_context |
| Memory Manager | execute_memory_syscall, add_memory, |
| | remove_memory, update_memory, |
| | retrieve_memory |
| Storage Manager | execute_storage_syscall, sto_create_file, |
| | sto_create_directory, sto_mount, sto_write, |
| | sto_retrieve, sto_rollback, sto_share |
| Tool Manager | execute_tool_syscall, load_tool_instance |
| Access Manager | add_privilege, check_access, ask_permission |

Thread Binding. In some embodiments, each system call in the AIOS framework is executed within a dedicated thread to enable parallel and concurrent processing across modules. In some embodiments, thread binding is implemented by subclassing the standard Thread class and overriding its_init_and run methods to customize initialization and execution behavior for each system call instance.

### AIOS-Agent SDK

The AIOS-Agent SDK was designed to provide developers with a versatile toolkit for constructing advanced agent applications within the AIOS framework. The SDK encompassed a broad range of functionalities, including agent-level operations such as updating agent configurations and generating execution plans, as well as system-level operations such as listing registered agents and monitoring their resource usage.

The SDK enables developers to construct agents capable of interacting with core functions provided by the AIOS kernel, while abstracting underlying system-level complexity. This abstraction allowed developers to concentrate on the internal logic and workflows of the agents without needing to manage low-level system calls.

Tool Integration. To support a broad spectrum of agent functionalities, the SDK integrates a diverse set of tools sourced from various platforms and capable of handling multiple input-output modalities.

Interaction Interface with the AIOS Kernel. To enable agent access to AIOS system-level functionality, the SDK defined a set of application programming interface (API) functions through which agents could invoke system calls and request system resources from the AIOS kernel.

Agent Framework Adapter. To ensure compatibility with agents developed using various third-party agent frameworks, the SDK provides corresponding framework adapters. These adapters identified the core functional components of the respective frameworks and redirected relevant calls to AIOS-native functions. This design permits agents developed with different frameworks to execute seamlessly within the AIOS environment.

The SDK provides a structured and modular interface between user-facing device applications and the AIOS kernel. The SDK includes multiple functional modules, each corresponding to a distinct category of kernel resources or services. All requests initiated by these modules are routed through functions within the SDK, which are configured to communicate with the AIOS kernel via direct function calling or Hypertext Transfer Protocol (HTTP) requests directed either to a local host address or a remote endpoint.

From the perspective of the agent developer, an agent is composed of one or more code components, which may include logic and command sequences associated with language model (LLM) operations, memory management, persistent storage, and tool access. These components interact with the kernel exclusively through the SDK application programming interfaces (APIs), thereby establishing a clean and modular separation between the agent's application logic and its access to underlying kernel resources.

### Query and Response Architecture

The SDK implements a robust and extensible query-response architecture to facilitate structured communication between agent applications and the AIOS kernel. This architecture is centered on two foundational data structures—Query and Response—that define standardized input and output formats, respectively.

### Query Structure

The Query class serves as an abstract base class for all input requests issued by agent applications. It defines a unified interface for interaction with the kernel and is extended through four specialized subclasses, each corresponding to a specific functional domain:

LLMQuery: Enables interaction with large language models. The query may include parameters such as temperature, token limits, and action types. Action types may include, but are not limited to, chat, JSON-formatted output, invocation of tool functions, and file operations.

MemoryQuery: Supports transient memory operations including the addition, retrieval, updating, and deletion of memory entries. This subclass includes specialized mechanisms for agentic memory management.

StorageQuery: Provides access to persistent storage operations. The query structure includes parameters for manipulating files and directories, including read, write, and delete operations.

ToolQuery: Facilitates access to external tools or capabilities by issuing structured tool call requests. This enables the extension of the agent's functionality beyond native kernel operations.

### AIOS-Agent SDK API Overview

As an example implementation, the SDK includes a collection of application programming interfaces (APIs) that are structured using standardized Query and Response data formats. These APIs are invoked through the send_request( ) function and are organized by functional modules as illustrated in Table 2 below.

TABLE 2
AIOS-Agent SDK APIs by Module

| Module | APIs |
|---|---|
| LLM | llm_chat, llm_chat_with_json_output, |
| Core(s) | llm_chat_with_tool_call_output, |
| | llm_call_tool, llm_operate_file |
| Memory | create_memory, get_memory, delete_memory, |
| | update_memory, search_memories |
| Storage | mount, retrieve_file, create_file, create_dir, |
| | write_file, rollback_file, share_file |
| Tool | call_tool |

### Response Structure

The Response class defines a standardized structure for outputs returned by the AIOS kernel in response to corresponding Query objects. Each response subclass is aligned with a specific query type:

LLMResponse: Provides the results of natural language generation tasks, including generated text, tool call outputs, completion status, and error information related to LLM operations.

MemoryResponse: Returns memory-related outputs, such as memory content, associated metadata, search results, and operation status.

StorageResponse: Conveys the outcome of storage operations, including confirmation of task completion and any relevant error details.

ToolResponse: Contains execution results from external tool operations, along with status indicators and error diagnostics, if applicable.

### Module Hooks

To facilitate a clean separation between the interface used to invoke AIOS kernel modules and the underlying implementation details, a hook-based mechanism is employed. This mechanism enables modular initialization and structured exposure of essential call interfaces. Specifically, predefined hooks are used to initialize individual modules and to register the corresponding interfaces required for interaction with other components of the system.

### Evaluation

In this section, the effectiveness and performance of AIOS modules when running multiple agents simultaneously was evaluated.

### Setup

The experiments are conducted using Python 3.11 with PyTorch 2.0.1 and CUDA 11.8 on an Ubuntu 22.04 machine equipped with 8 NVIDIA RTX A5000 GPUs. Four different LLMs: Mistral-7B, Llama-3-8B, GPT-3.5-turbo and GPT-4, were utilize respectively, as the core of AIOS to account for both open-source and closed-source scenarios. For the open-source models, Mistral-7B and Llama-3-8B, their instruction-tuned versions were employed. Five different types of specialized agents (TravelAgent, RecAgent, CreationAgent, MathAgent, and AcademicAgent) were configured to evaluate the effectiveness of AIOS modules. Unless otherwise specified, one instance of each type of agent (i.e., 5 agent instances in total) by default throughout the experiments was used. Additionally, the number of agent instances was increased to assess the scalability of AIOS.

TABLE 3
Comparative analysis between AIOS-scheduled execution and two execution
baselines, where S denotes sequential execution, C denotes concurrent
execution without AIOS, AIOS-C denotes AIOS scheduled concurrent execution.
Lower values of time latency indicate better efficiency.

| | | Agent- | Agent- | Agent- | Agent- |
|---|---|---|---|---|---|
| | | level | level | level | level |
| LLM | | Waiting | Waiting | Turnaround | Turnaround |
| core | Execution | Avg | p90 | Avg | p90 |
| Mistral- | S | 220.01 ± 9.1 | 372.53 ± 11.83 | 301.22 ± 10.64 | 396.91 ± 13.79 |
| 7B | | | | | |
| Mistral- | C | 94.92 ± 5.35 | 236.91 ± 7.61 | 166.42 ± 5.42 | 296.56 ± 9.40 |
| 7B | | | | | |
| Mistral- | AIOS-C | 22.95 ± 2.02 | 41.48 ± 3.43 | 161.36 ± 5.49 | 295.00 ± 8.89 |
| 7B | | | | | |
| Llama-3- | S | 293.59 ± 9.23 | 387.64 ± 14.62 | 214.26 ± 7.46 | 361.51 ± 11.62 |
| 8B | | | | | |
| Llama-3- | C | 95.04 ± 5.01 | 233.86 ± 9.12 | 166.88 ± 7.90 | 291.69 ± 9.47 |
| 8B | | | | | |
| Llama-3- | AIOS-C | 22.96 ± 1.92 | 41.55 ± 2.24 | 159.67 ± 7.23 | 290.06 ± 10.12 |
| 8B | | | | | |
| GPT-3.5- | S | 29.31 ± 1.32 | 51.60 ± 3.11 | 41.90 ± 1.89 | 60.15 ± 2.44 |
| turbo | | | | | |
| GPT-3.5- | C | 19.45 ± 1.13 | 45.08 ± 2.82 | 35.45 ± 1.41 | 36.93 ± 2.64 |
| turbo | | | | | |
| GPT-3.5- | AIOS-C | 5.39 ± 0.87 | 9.69 ± 1.11 | 18.07 ± 1.52 | 49.47 ± 6.20 |
| turbo | | | | | |
| GPT-4 | S | 108.42 ± 6.17 | 184.80 ± 8.82 | 151.76 ± 7.23 | 206.50 ± 9.20 |
| GPT-4 | C | 38.52 ± 2.07 | 97.35 ± 3.88 | 70.06 ± 3.23 | 124.45 ± 4.65 |
| GPT-4 | AIOS-C | 6.93 ± 0.58 | 12.51 ± 0.84 | 66.78 ± 3.14 | 118.02 ± 4.01 |

| | Agent- | Agent- | Agent- | Agent- |
|---|---|---|---|---|
| | request | request | request | request |
| LLM | Waiting | Waiting | Turnaround | Turnaround |
| core | Avg | p90 | Avg | p90 |
| Mistral- | 57.84 ± 4.02 | 337.40 ± 9.81 | 79.11 ± 4.02 | 348.08 ± 10.13 |
| 7B | | | | |
| Mistral- | 22.01 ± 2.38 | 52.86 ± 3.52 | 43.37 ± 3.02 | 66.88 ± 3.97 |
| 7B | | | | |
| Mistral- | 20.95 ± 1.98 | 50.28 ± 3.65 | 42.27 ± 2.50 | 65.97 ± 3.92 |
| 7B | | | | |
| Llama-3- | 56.32 ± 4.01 | 327.43 ± 10.79 | 77.09 ± 4.21 | 338.21 ± 10.91 |
| 8B | | | | |
| Llama-3- | 22.35 ± 1.99 | 54.26 ± 3.06 | 43.26 ± 2.51 | 68.34 ± 3.42 |
| 8B | | | | |
| Llama-3- | 21.03 ± 1.41 | 50.02 ± 2.40 | 41.74 ± 2.31 | 66.52 ± 3.44 |
| 8B | | | | |
| GPT-3.5- | 10.38 ± 0.97 | 43.86 ± 1.78 | 13.10 ± 1.32 | 46.44 ± 2.12 |
| turbo | | | | |
| GPT-3.5- | 4.44 ± 0.51 | 11.94 ± 0.89 | 7.32 ± 0.72 | 14.79 ± 0.96 |
| turbo | | | | |
| GPT-3.5- | 2.62 ± 0.42 | 10.57 ± 0.82 | 6.37 ± 0.72 | 13.20 ± 0.95 |
| turbo | | | | |
| GPT-4 | 38.63 ± 2.85 | 172.97 ± 5.22 | 42.43 ± 3.01 | 176.11 ± 5.46 |
| GPT-4 | 8.30 ± 0.82 | 21.84 ± 4.91 | 13.60 ± 1.54 | 33.80 ± 2.07 |
| GPT-4 | 7.32 ± 0.62 | 26.27 ± 1.98 | 11.60 ± 0.72 | 32.02 ± 1.93 |

TABLE 4
Evaluation of agent performance on various benchmarks, comparing
performance without AIOS and with AIOS. The success rate (SR
%) was used as the evaluation metric across all benchmark tasks.
A dash (“—”) indicated methods that failed to complete
tasks in the GAIA benchmark due to a lack of API support.

| | | | | SWE- |
|---|---|---|---|---|
| | | MINT | | Bench- |
| Method | HumanEval | (Code) | GAIA | Lite |
| ReAct w/o AIOS | 48.8 | 29.4 | 5.5 | 3.9 |
| ReAct w/ AIOS | 50.6 | 30.1 | 7.3 | 4.3 |
| Reflexion w/o AIOS | 50.6 | 32.4 | 6.7 | 4.7 |
| Reflexion w/ AIOS | 51.8 | 33.8 | 7.8 | 5.1 |
| Autogen w/o AIOS | 87.8 | 42.5 | 7.3 | 4.3 |
| Autogen w/ AIOS | 87.8 | 42.5 | 9.7 | 4.3 |
| Open-Interpreter w/o AIOS | 85.4 | 45.9 | — | 4.7 |
| Open-Interpreter w/ AIOS | 86.0 | 48.7 | — | 5.1 |
| MetaGPT w/o AIOS | 82.9 | 41.1 | — | 5.9 |
| MetaGPT w/ AIOS | 82.9 | 41.8 | — | 5.9 |

TABLE 5
Illustrates the impact of employing different scheduling strategies
within the AIOS framework. The row labeled “NONE” corresponds
to a baseline condition in which AIOS is not utilized. The rows
labeled “FIFO” and “RR” correspond to configurations
where AIOS is enabled with, respectively, a first-in-first-out
(FIFO) scheduling strategy and a round-robin (RR) scheduling
strategy. All performance metrics are reported in seconds.

| | | Agent | Agent |
|---|---|---|---|
| | Overall | waiting | waiting |
| | execution | time | time |
| Strategy | time | (Avg.) | (p90) |
| None | 152.1 | 9.8 | 11.0 |
| FIFO | 74.2 | 3.0 | 5.0 |
| RR | 77.3 | 3.2 | 4.2 |

### Effectiveness of Scheduler

To evaluate the effectiveness of the scheduler, two execution baselines were considered and implemented. The first baseline is sequential execution, where agents are scheduled one-by-one, with each agent completing all its steps before the next agent begins. The second baseline is a concurrent execution approach, commonly used in agent creation frameworks, which employs multi-processing to run multiple python scripts simultaneously to execute agents. In the experiments, the same initialization order was maintained for all agent instances to minimize variations, thereby ensuring a fair comparison.

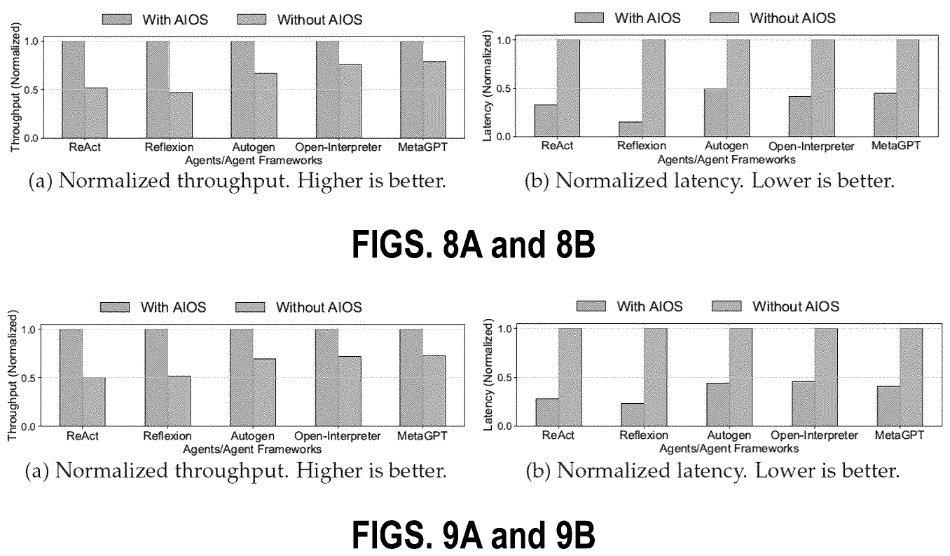

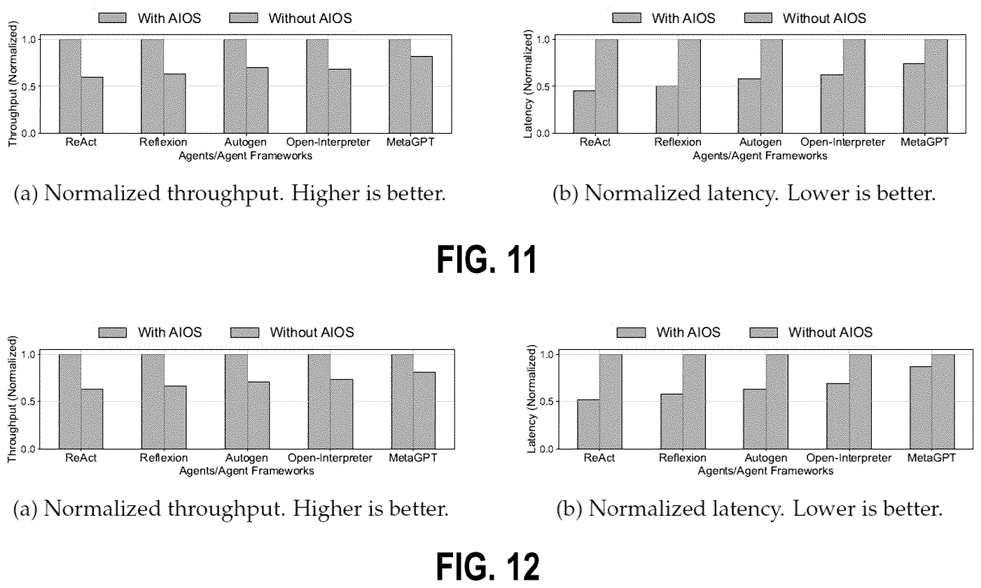

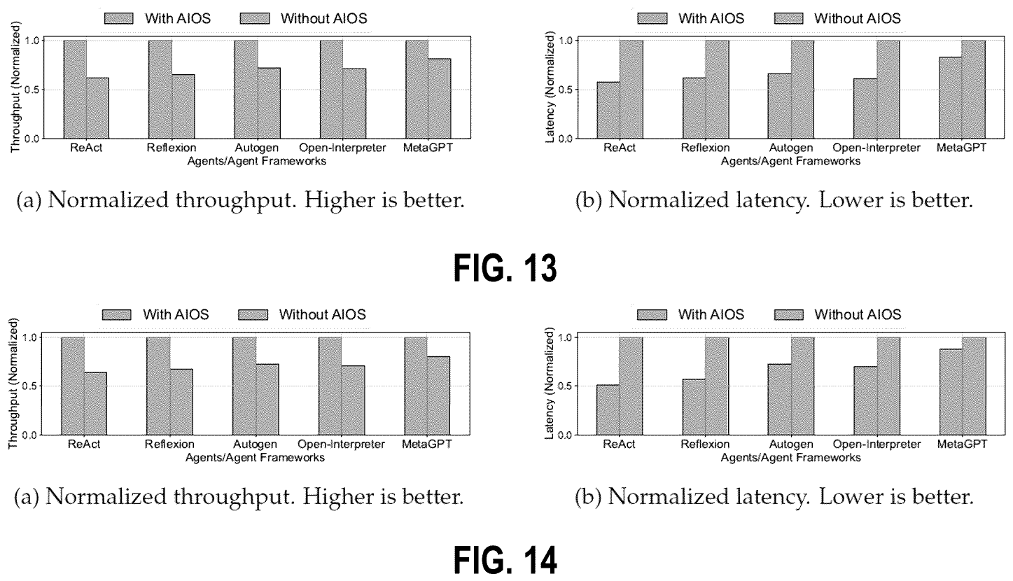

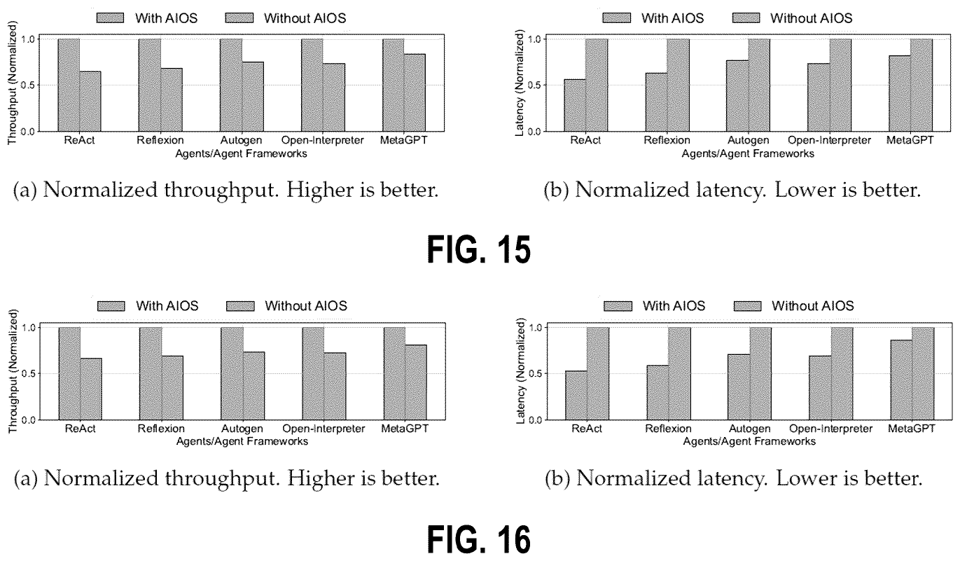

Comparative Analysis. Two metrics were used to evaluate temporal efficiency: waiting time (the interval from the submission of an agent's request to the start of processing) and turnaround time (the total time from the submission of an agent's request to its completion). Since each agent sends multiple requests to the LLM, waiting time and turnaround time were measured at both the agent level and the agent-request level. Specifically, the average and the 90th percentile (p90) of these time latencies were calculated, where p90 represents the value below which 90% of the data points fall. Five trials were performed with different random seeds to reduce the randomness. As shown in Table 3, AIOS-C surpasses almost all the metrics against the two baselines among the different LLMs and significantly improves the agent-level waiting time, which benefits the experience of using agents. Furthermore, FIGS. 8, 9, and 11-16 demonstrate improved throughput and reduced latency for agent execution based on AIOS across various LLM backbones and benchmark datasets. Compared with sequential execution, AIOS scheduler makes the largest use of LLM resources, reducing the idle time of LLM. Besides, unlike the concurrent baselines, AIOS uses the multi-thread mechanisms instead of initializing process objects at the start of the agents, which helps explain why AIOS scheduler reduces the agent-level waiting time.

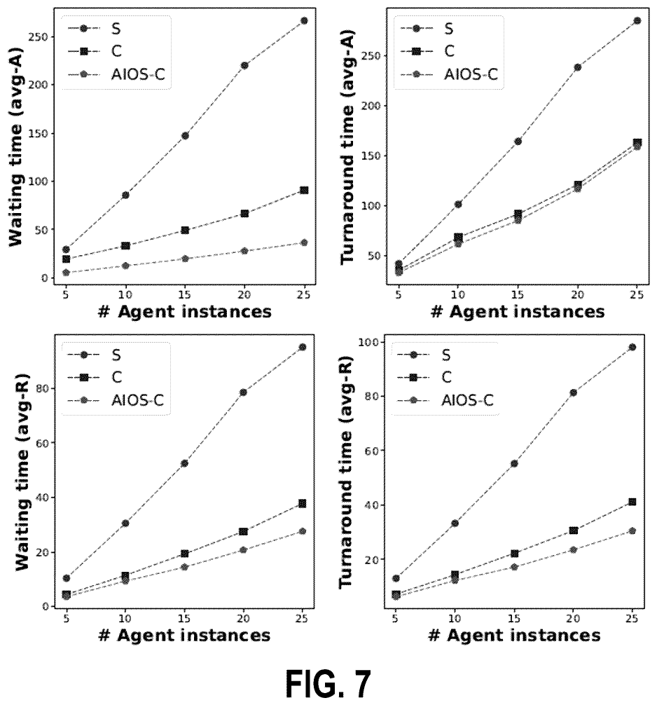

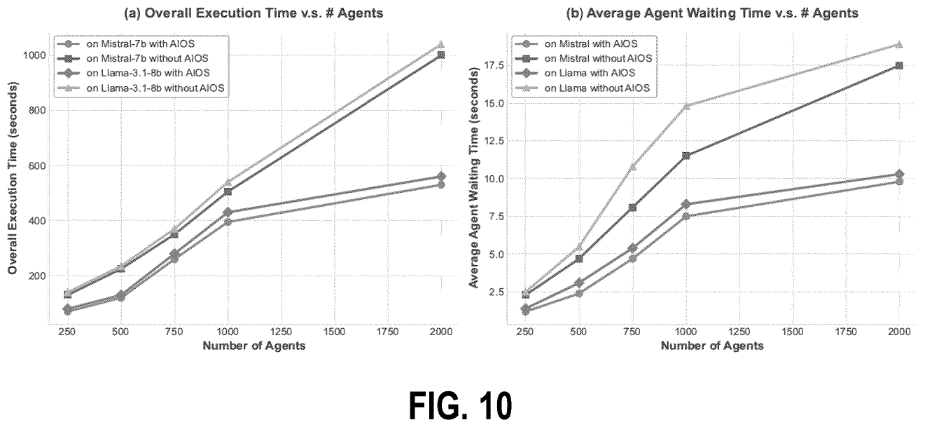

Scalability Analysis. To evaluate the scalability of AIOS, the number of agent instances was increased from 5 to 25 by using different task inputs to generate multiple instances for each type of agent. Time metrics were then utilized to assess the performance of AIOS as the number of agent instances increased. As shown in FIG. 7, the time latency generally exhibits a linear relationship with the increase in agent instances. To further evaluate the scalability under extreme settings, the number of agent instances was further increased from 250 to 2000 with time metrics assessed. As shown in FIG. 10 which assesses the overall execution time and the average agent waiting time, it further demonstrates that the system performance scales well with agent population, highlighting trends in computational load and latency experienced by individual agents. The linear increase in time latency suggests that AIOS efficiently handles additional load without significant degradation in performance. Moreover, the gap between the AIOS-scheduled time latency and the other two scheduling methods demonstrates an upward trend. This observation indicates that AIOS maintains stability in managing multiple agents and exhibits a scalability advantage, particularly in scenarios with a high density of agents.

TABLE 6
Effectiveness of context manager (text-based and logits-based).

| LLM core | Context Management | BLEU Score | BERT Score |
|---|---|---|---|
| Mistral-7B | Text-based | 1.0 | 1.0 |
| | Logits-based | 1.0 | 1.0 |
| Llama-3-8B | Text-based | 1.0 | 1.0 |
| | Logits-based | 1.0 | 1.0 |

### Effectiveness of Context Manager

To assess the consistency of outputs when multiple agents are run simultaneously compared to independently running agents, the BLEU score and BERT score were employed to measure text similarity. Both metrics range from 0.0 to 1.0, with the outputs produced in a single-agent context serving as the reference standard. To eliminate the impact of randomness, the temperature parameter was set to 0. As demonstrated in Table 6, both BLEU and BERT scores achieve a value of 1.0, indicating perfect alignment between the outputs generated by running agents simultaneously and those generated by running agents independently. This suggests that the context manager ensures that concurrent execution of agents does not introduce discrepancies in output quality. This consistency is critical for maintaining the integrity and reliability of the AIOS system in multi-agent environments.

### Effectiveness of Memory & Storage Manager

TABLE 7
Physical space usage of agents w/ and w/o AIOS management.

| | | Physical memory | Physical storage |
|---|---|---|---|
| LLM core | Management | usage (average) | usage (average) |
| Mixtral-7B | w/o AIOS | 9.83KB | 8.16KB |
| | w AIOS | 7.42KB | 5.91KB |
| | | (↓ 24.52%) | (↓ 27.57%) |
| Llama-3-8B | w/o AIOS | 10.25KB | 9.34KB |
| | w AIOS | 7.90KB | 6.99KB |
| | | (↓ 22.93%) | (↓ 25.16%) |
| GPT-3.5-turbo | w/o AIOS | 13.58KB | 10.76KB |
| | w AIOS | 10.12KB | 6.88KB |
| | | (↓ 25.48%) | (↓ 36.06%) |
| GPT-4 | w/o AIOS | 12.19KB | 9.61KB |
| | w AIOS | 9.36KB | 6.40KB |
| | | (↓ 23.22%) | (↓ 31.62%) |

In this section, the effectiveness of the memory manager and storage manager in reducing the space used by agents was assessed. Five agent instances were simultaneously run with and without the AIOS memory manager, respectively, and the physical memory usage of each agent every 10 seconds to record their average memory consumption during runtime was monitored. Upon completion of the agent tasks, their interaction history (including queries, responses from the LLM, and tool calling logs) was stored with and without the AIOS storage manager, respectively, and then compare the size of stored files. The results presented in Table 7 indicate that our memory manager and storage manager can reduce space usage by at least 20%, demonstrating the efficiency of these modules.

The present disclosure provides an AIOS architecture configured to support the development and deployment of LLM-based agents. The AIOS architecture enables improved cohesion, operational efficiency, and scalability within an AIOS-agent ecosystem. Experimental results demonstrate that the disclosed architecture facilitates the concurrent operation of multiple agents, validating the effectiveness and performance of the AIOS design and implementations.

The AIOS as disclosed can be implemented as Single-core AIOS and Multi-core AIOS. In Single-core AIOS, there is only one LLM in the LLM-kernel, and this LLM handles all of the agent requests. In Multi-core AIOS, there are more than one LLMs in the LLM-kernel, and there is an LLM-router which automatically routes the agent requests to the best LLM: if the request is simple, the it will be handled by a small and cheap LLM, if the request is very difficult, then it will be handled by a large and expensive LLM; this can help agent developers to save money and in the meantime gain optimal performance, achieving the best balance between cost and effectiveness.

In some embodiments, AIOS also provides an agent adaptor. The adaptor converts any agent application to be compatible with the AIOS platform, so that any agent can run on the AIOS system. In some embodiments, AIOS provides encryption and compression functions for agents. When agents want to store information on AIOS, AIOS can encrypt such information to guarantee the information security, AIOS can also compress the information to save storage space.

An LLM is a type of artificial intelligence (AI) program that uses machine learning to generate and interpret language. LLMs are trained on large amounts of data, such as billions of words of text, and can perform a variety of natural language processing (NLP) tasks. LLMs are often based on deep learning architectures, such as the Transformer developed by Google in 2017. The Transformer is a set of neural networks that use the idea of “attention” to connect certain neurons more strongly than others in a sequence. This architecture works well with text-based data because words are read in sequence, and different parts of a sentence can modify or refer to each other.

In one aspect, this disclosure provides an LLM-based agent operating system comprising an application layer, a kernel layer, and a hardware layer. In some embodiments, the kernel layer comprises a kernel comprising: one or more LLM cores to process agent requests and/or prompts; an agent scheduler configured to prioritize and schedule agent requests from one or more agents to optimize LLM utilization; a context manager configured to support context management during a generation process of LLM responses; a memory manager configured to manage short-term or long-term memory or context information for each agent's interaction logs; a storage manager configured to persist agent interaction logs or knowledge base to long-term storage for future retrieval; and a system call interface configured to manage interactions among the agent scheduler, the context manager, the memory manager, and the storage manager.

As used herein, the term “agent operating system” or “AIOS” refers to a software-based infrastructure layer configured to manage, coordinate, and facilitate the execution of multiple autonomous agents, such as LLM-based agents, within a shared computational environment. The agent operating system provides core functionalities including task scheduling, memory and context management, communication protocols between agents, resource allocation, lifecycle management, and interfacing with external systems or users. In some embodiments, the agent operating system may further include tools or services for monitoring agent performance, dynamically updating agent behavior, or orchestrating complex multi-agent workflows. The agent operating system is designed to support scalable, modular, and efficient deployment of agent-based applications across local or distributed computing environments.

As used herein, the term “application layer” refers to a software framework or architecture that facilitates the execution, coordination, and lifecycle management of autonomous agents, such as LLM-based agents, within an agentic computing environment. The application layer of the agent operating system provides high-level services, protocols, and interfaces that enable agent behaviors, task orchestration, inter-agent communication, memory management, context retrieval, decision-making, and user interaction. This layer abstracts underlying infrastructure components and exposes standardized APIs to allow modular integration and deployment of agent functionalities across diverse tasks and platforms.

As used herein, the term “kernel layer” refers to a foundational software component of an AIOS responsible for managing low-level functions that enable coordination, execution, and communication among agent processes. The kernel layer provides core services such as task scheduling, memory management, input/output control, inter-agent messaging, and resource allocation. In some embodiments, the kernel layer abstracts hardware or infrastructure dependencies and exposes standardized interfaces for higher-level agent modules, thereby facilitating modularity, scalability, and efficient orchestration of agent behavior within the system.

As used herein, the term “hardware layer” refers to the physical computing resources and infrastructure that underlie and support the execution of the agent operating system and its associated agents. The hardware layer may include one or more processors (e.g., central processing units, graphics processing units, tensor processing units), memory devices (e.g., RAM, cache, persistent storage), networking interfaces, and other hardware components such as sensors, accelerators, and input/output devices. The hardware layer provides the foundational computational, storage, and communication capabilities upon which higher-level software abstractions and agent functionalities are built and executed.

As used herein, the term “agent scheduler” refers to a software-based or hardware-implemented component of an agent operating system configured to manage the execution, prioritization, and coordination of multiple autonomous agents or agentic processes. The agent scheduler allocates computational resources, assigns execution order, enforces task dependencies, and ensures efficient and scalable operation of agent workloads, which may include LLM-based agents. In some embodiments, the agent scheduler may implement time-based, priority-based, event-driven, or adaptive scheduling policies, and may support parallel, concurrent, or distributed execution of agents within a shared or multi-tenant runtime environment.

As used herein, a “context manager” refers to a system component, software module, or service within an AIOS that is configured to track, organize, update, and provide contextual information relevant to the operation of one or more agents. The context manager may maintain real-time or historical data related to agent interactions, environmental states, user queries, memory states, or task objectives, and may provide such contextual information to support decision-making, memory recall, task planning, or natural language generation. In some embodiments, the context manager comprises one or more context stores, indexing mechanisms, retrieval engines, or semantic representation modules to facilitate dynamic and adaptive context management. The context manager may operate locally on an agent device, across a distributed system, or within a centralized infrastructure.

As used herein, the term “memory manager” refers to a component of an agent operating system configured to manage the storage, organization, retrieval, and updating of memory representations associated with one or more artificial intelligence (AI) agents. The memory manager may facilitate the dynamic allocation of memory resources, the indexing and linking of contextual information, and the maintenance of structured memory elements (e.g., notes, embeddings, or knowledge graphs) based on interactions, tasks, or experiences of the agent. In some embodiments, the memory manager may include functionality for semantic retrieval, memory pruning, temporal organization, or memory reinforcement, and may be implemented using rule-based logic, neural architectures, vector databases, or combinations thereof.

As used herein, the term “storage manager” refers to a software and/or hardware component of an agent operating system configured to manage the storage, retrieval, indexing, and lifecycle of data objects associated with one or more intelligent agents. The storage manager may be responsible for organizing structured and unstructured data, including but not limited to agent memory states, interaction logs, contextual embeddings, knowledge artifacts, and intermediate computational results. In some embodiments, the storage manager interfaces with memory systems, databases, file systems, or cloud storage services to provide persistent or ephemeral storage optimized for agent-based workflows. The storage manager may also implement policies for data retention, synchronization, compression, encryption, or access control to ensure efficient and secure operation within a multi-agent or distributed environment.

As used herein, the term “system call interface” refers to a defined set of application programming interfaces (APIs), functions, or invocation mechanisms through which one or more agent-based software entities interact with underlying operating system services and resources. In the context of an agent operating system, the system call interface enables agent processes to request and utilize core functionalities provided by the operating system infrastructure, such as task scheduling, inter-agent communication, memory management, input/output operations, data retrieval, or resource orchestration. The system call interface may be implemented using function calls, message-passing protocols, or other suitable communication mechanisms that abstract hardware and system-level operations from the agents.

In some embodiments, the agent operating system further comprises a tool manager configured to manage tool calling of the agents. In some embodiments, the agent operating system further comprises an access manager configured to enforce security, privacy and access control policies between the agents, and between the agents and the agent operating system.

In some embodiments, the agent operating system further comprises an agent operating system-agent SDK that interfaces agents and the kernel layer. In some embodiments, the agent operating system-agent SDK comprises one or more toolkits for developing agent applications.

As used herein, the term “agent operating system-agent SDK” refers to a computing framework or platform that provides core infrastructure, libraries, tools, and standardized interfaces to support the development, deployment, execution, coordination, and management of autonomous or semi-autonomous software agents. The agent operating system-agent SDK may include functionalities for agent lifecycle management, inter-agent communication, memory and context handling, task scheduling, security, logging, and integration with LLMs or other AI systems. In some embodiments, the agent operating system-agent SDK enables the development of modular, extensible agent behaviors and allows seamless deployment across distributed environments.

In some embodiments, the kernel layer further comprises an OS kernel. In some embodiments, the agent operating system-agent SDK directs LLM or non-LLM related calls to the LLM kernel and the OS kernel respectively.

In some embodiments, the kernel layer further comprises an OS kernel. In some embodiments, the agent operating system-agent SDK directs LLM or non-LLM related calls to the agent operating system kernel and the OS kernel respectively.

In some embodiments, the agent scheduler manages the agent requests and balances waiting time and turnaround time of each agent request. In some embodiments, the agent scheduler manages the agent requests based on First-In-First-Out, Round Robin, or other scheduling algorithms.

In some embodiments, the agent scheduler manages the agent requests and balances waiting time and turnaround time of each agent request. In some embodiments, the agent scheduler manages the agent requests based on First-In-First-Out (FIFO) or Round Robin or other scheduling algorithms. In addition to First-In-First-Out (FIFO) and Round Robin, several other scheduling algorithms are commonly used in operating systems. Shortest Job First (SJF) selects the process with the shortest execution time, minimizing average wait time but risking starvation for longer tasks. Priority Scheduling executes processes based on assigned priority levels and can be preemptive or non-preemptive, though it may also lead to starvation of lower-priority processes. Multilevel Queue Scheduling organizes processes into distinct queues based on categories such as system or interactive tasks, each with its own scheduling policy. Multilevel Feedback Queue Scheduling improves on this by allowing processes to move between queues based on behavior and wait time, enhancing fairness and adaptability. Earliest Deadline First (EDF) is used in real-time systems to run the task closest to its deadline, ensuring timely execution of time-sensitive operations. Fair Share Scheduling allocates CPU time among user groups rather than individual processes to maintain equity in multi-user environments. Each algorithm is suited to different system goals, such as efficiency, fairness, responsiveness, or real-time constraints.

In some embodiments, the context manager supports context interruption and switching based on context snapshot and context restoration mechanisms. In some embodiments, the snapshot and context restoration mechanisms are text-based or logits-based.

In some embodiments, the memory manager manages short-term or long-term memory or context information within each round of an agent interaction. In some embodiments, the memory manager stores memory of an agent and permits access to the memory when the agent is active, either waiting for execution or during execution.

In some embodiments, the storage manager manages long-term preservation of data and storage of information that needs to be retained beyond an active lifespan of an agent.

In some embodiments, the tool manager manages a diverse array of API tools that enhance the functionality of an LLM or agent.

In some embodiments, the access manager provides security and privacy guarantee and access control among distinct agents by administering a dedicated privilege group for each agent.

In some embodiments, the agent operating system is implemented with one or more LLMs in the agent operating system kernel.

In some embodiments, the application layer comprises one or more agent applications. In some embodiments, the agent applications are LLM-based applications.

In some embodiments, the hardware layer comprises CPU, GPU, memory, disk, and/or peripheral devices.

As used herein, a “machine learning model,” a “model,” or a “classifier” refers to a set of algorithmic routines and parameters that can predict an output(s) for a process input based on a set of input features, with or without being explicitly programmed. A structure of the software routines (e.g., number of subroutines and relation between them) and/or the values of the parameters can be determined in a training process, which can use actual results of the process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology. A neural network or an artificial neural network is one set of algorithms used in machine learning for modeling the data using graphs of neurons. Any network structure may be used. Any number of layers, nodes within layers, types of nodes (activations), types of layers, interconnections, learnable parameters, and/or other network architectures may be used. Machine training uses the defined architecture, training data, and optimization to learn values of the learnable parameters of the architecture based on the samples and ground truth of training data.

A typical machine learning pipeline may include building a machine learning model from a sample dataset (referred to as a “training set”), evaluating the model against one or more additional sample datasets (referred to as a “validation set” and/or a “test set”) to decide whether to keep the model and to benchmark how good the model is, and using the model in “production” to make predictions or decisions against live input data captured by an application service. For training the model to be applied as a machine-learned model, training data is acquired and stored in a database or memory. The training data is acquired by aggregation, mining, loading from a publicly or privately formed collection, transfer, and/or access. Ten, hundreds, or thousands of samples of training data are acquired. The samples are from scans of different patients and/or phantoms. Simulation may be used to form the training data. The training data includes the desired output (ground truth), such as segmentation, and the input, such as protocol data and imaging data.

In some embodiments, the training set will be used to create a single classifier using any now or hereafter-known methods. In other embodiments, a plurality of training sets will be created to generate a plurality of corresponding classifiers. Each of the plurality of classifiers can be generated based on the same or different learning algorithm that utilizes the same or different features in the corresponding one of the pluralities of training sets.

Once trained, the machine-learned or trained classifier is stored for later application. The training determines the values of the learnable parameters of the network. The network architecture, values of non-learnable parameters, and values of the learnable parameters are stored as the machine-learned network. Once stored, the machine-learned network may be fixed. The same machine-learned network may be applied to different patients, different scanners, and/or with different imaging protocols for the scanning. The machine-learned network may be updated. As additional training data is acquired, such as through application of the network for patients and corrections by experts to that output, the additional training data may be used to re-train or update the training.

For the machine learning model, input data structures of subreads can be used for the training. The training is performed by optimizing parameters of the model based on outputs of the model matching or not matching corresponding labels of the first labels and optionally the second labels when the first plurality of first data structures and optionally the second plurality of second data structures are input to the model.

In some embodiments, the machine learning model may further include a supervised learning model. Supervised learning models may include different approaches and algorithms including analytical learning, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, Nearest Neighbor Algorithm, probably approximately correct learning (PAC) learning, ripple down rules, a knowledge acquisition methodology, symbolic machine learning algorithms, subsymbolic machine learning algorithms, support vector machines, Minimum Complexity Machines (MCM), random forests, ensembles of classifiers, ordinal classification, data pre-processing, handling imbalanced datasets, statistical relational learning, or Proaftn, a multicriteria classification algorithm, linear regression, logistic regression, deep recurrent neural network (e.g., long short term memory, LSTM), Bayes classifier, hidden Markov model (HMM), linear discriminant analysis (LDA), k-means clustering, density-based spatial clustering of applications with noise (DBSCAN), random forest algorithm, support vector machine (SVM), or any model described herein.

### Additional Definitions

To aid in understanding the detailed description of the compositions and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

As used herein, the terms “memory,” “memory device,” “computer-readable storage medium,” “data store,” “data storage facility,” and the like each refer to a non-transitory device on which computer-readable data, programming instructions or both are stored. Except where specifically stated otherwise, the terms “memory,” “memory device,” “computer-readable storage medium,” “data store,” “data storage facility,” and the like are intended to include single device embodiments, embodiments in which multiple memory devices together or collectively store a set of data or instructions, as well as individual sectors within such devices.

As used herein, the terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The terms “instructions” and “programs” may be used interchangeably herein. The instructions may be stored in object code format for direct processing by the processor, or in any other computing device language, including scripts or collections of independent source code modules that are interpreted on demand or compiled in advance. Functions, methods, and routines of the instructions are explained in more detail below. The instructions may be any set of instructions to be executed directly (such as machine code) or indirectly (such as scripts) by the processor. For example, the instructions may be stored as computing device code on the computing device-readable medium.

In addition, the terms “unit,” “-er,” “-or,” and “module” described in the specification mean units for processing at least one function and operation, and can be implemented by hardware components or software components and combinations thereof.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

Aspects of the present disclosure are described herein with reference to flowchart illustrations and/or block diagrams of methods, apparatus (systems), and computer program products according to embodiments of the invention. In some embodiments, the flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Unless specifically stated otherwise, it is appreciated that throughout the disclosure, descriptions utilizing terms such as “obtaining,” “performing,” “receiving,” “computing,” “associating,” “assigning,” “traversing,” “calculating,” “determining,” “identifying,” “transforming,” “ranking,” “providing,” “transmitting,” or the like, refer to the action and processes of a computer system, or similar electronic computing device, that manipulates and transforms data represented as physical (or electronic) quantities within the computer system memories or registers or other such information storage, transmission or display devices.

As used herein, the term “logistic regression” is a regression model for binary data from statistics where the logit of the probability that the dependent variable is equal to one is modeled as a linear function of the dependent variables.

As used herein, the term “neural network” is a machine learning model for classification or regression consisting of multiple layers of linear transformations followed by element-wise nonlinearities typically trained via stochastic gradient descent and back-propagation.

The term “machine learning,” as used herein, refers to a computer algorithm used to extract useful information from a database by building probabilistic models in an automated way.

The term “regression tree,” as used herein, refers to a decision tree that predicts values of continuous variables.

As used herein, the term “if may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

It will be understood that, although the terms “first,” “second,” etc., may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

It is noted here that, as used in this specification and the appended claims, the singular forms “a,” “an,” and “the” include plural reference unless the context clearly dictates otherwise. The terms “including,” “comprising,” “containing,” or “having” and variations thereof are meant to encompass the items listed thereafter and equivalents thereof as well as additional subject matter unless otherwise noted.

The phrases “in one embodiment,” “in various embodiments,” “in some embodiments,” and the like are used repeatedly. Such phrases do not necessarily refer to the same embodiment, but they may unless the context dictates otherwise.

The terms “and/or” or “/” means any one of the items, any combination of the items, or all of the items with which this term is associated.

As used herein, the term “each,” when used in reference to a collection of items, is intended to identify an individual item in the collection but does not necessarily refer to every item in the collection. Exceptions can occur if explicit disclosure or context clearly dictates otherwise.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All methods described herein are performed in any suitable order unless otherwise indicated herein or otherwise clearly contradicted by context. In regard to any of the methods provided, the steps of the method may occur simultaneously or sequentially. When the steps of the method occur sequentially, the steps may occur in any order, unless noted otherwise.

In cases in which a method comprises a combination of steps, each and every combination or sub-combination of the steps is encompassed within the scope of the disclosure, unless otherwise noted herein.

Each publication, patent application, patent, and other reference cited herein is incorporated by reference in its entirety to the extent that it is not inconsistent with the present disclosure. Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates which may need to be independently confirmed.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A large language model (LLM)-based agent operating system comprising an application layer, a kernel layer, and a hardware layer, wherein the kernel layer comprises an LLM kernel comprising:
one or more LLM cores that process agent requests;
an agent scheduler configured to prioritize and schedule agent requests from one or more agents to optimize LLM utilization;
a context manager configured to support context management during a generation process of LLM responses;
a memory manager configured to manage short-term or long-term memory or context information for each agent's interaction logs;
a storage manager configured to persist agent interaction logs or knowledge base to long-term storage for future retrieval; and
a system call interface configured to manage interactions among the agent scheduler, the context manager, the memory manager, and the storage manager.

2. The agent operating system of claim 1, further comprising a tool manager configured to manage an external tool calling of the agents.

3. The agent operating system of claim 1, further comprising an access manager configured to enforce security, privacy and access control policies between the agents, and between agents and the agent operating system.

4. The agent operating system of claim 1, further comprising an agent operating system-agent SDK that interfaces agents and the kernel layer.

5. The agent operating system of claim 1, wherein the agent operating system-agent SDK comprises one or more toolkits for developing agent applications.

6. The agent operating system of claim 1, wherein the kernel layer further comprises an OS kernel.

7. The agent operating system of claim 6, wherein the agent operating system-agent SDK directs LLM or non-LLM related calls to the LLM kernel and the OS kernel respectively.

8. The agent operating system of claim 1, wherein the agent scheduler manages the agent requests and balances waiting time and turnaround time of each agent request.

9. The agent operating system of claim 8, wherein the agent scheduler manages the agent requests based on a scheduling algorithm.

10. The agent operating system of claim 9, wherein the scheduling algorithm comprises First-in-First-Out or Round Robin.

11. The agent operating system of claim 1, wherein the context manager supports context interruption and switching based on context snapshot and context restoration mechanisms.

12. The agent operating system of claim 11, wherein the snapshot and context restoration mechanisms are text-based or logits-based.

13. The agent operating system of claim 1, wherein the memory manager manages short-term or long-term memory or context information within each round of an agent interaction.

14. The agent operating system of claim 1, wherein the memory manager stores memory of an agent and permits access to the memory when the agent is active, either waiting for execution or during execution.

15. The agent operating system of claim 1, wherein the storage manager manages long-term preservation of data and storage of information that needs to be retained beyond an active lifespan of an agent.

16. The agent operating system of claim 2, wherein the tool manager manages a diverse array of API tools that enhance the functionality of an LLM.

17. The agent operating system of claim 3, wherein the access manager provides access control among distinct agents by administering a dedicated privilege group for each agent.

18. The agent operating system of claim 1, wherein the agent operating system is implemented with one or more LLMs in the LLM kernel.

19. The agent operating system of claim 1, wherein the application layer comprises one or more agent applications.

20. The agent operating system of claim 19, wherein the agent applications are LLM-based applications.

21. The agent operating system of claim 1, wherein the hardware layer comprises CPU, GPU, memory, disk, and/or peripheral devices.
